(19) United States
(12) Patent Application Publication
(10) Pub. No.: US 2025/0286294 A1
(43) Pub. Date: Sep. 11, 2025

(54) Electrical Contact

(71) Applicant: Lumberg Connect GmbH, Schalksmuehle (DE)

(72) Inventors: Michael Stracke, Balve (DE); Torsten Jockel, Luedenscheid (DE); Dirk Pfaffenbach, Halver (DE); Luca Inzinna, Sprockhoevel (DE)

(21) Appl. No.: 19/066,106

(22) Filed: Feb. 27, 2025

(30) Foreign Application Priority Data
Mar. 7, 2024 (DE) 102024106526.5

(51) Int. Cl. H01R 12/71; H01R 12/70; H01R 13/11

(52) U.S. Cl. CPC H01R 12/718; H01R 12/707; H01R 13/112; H01R 2201/26

(57) ABSTRACT

An electrical contact including two side walls arranged opposite to one another; a rear wall arranged between the two side walls, wherein the two side walls form a contact cage together with the rear wall; a plug in gap formed by two contact lips arranged opposite to one another, wherein each contact lip of the two contact lips forms a respective contact surface, wherein the respective contact surfaces of the two contact lips are oriented towards each other, wherein each contact lip of the two contact lips arranged in the contact cage is oriented essentially parallel to the two side walls, wherein each contact lip of the two contact lips is formed by a respective side wall section bent into the contact cage, wherein each respective side wall section forms a free end oriented away from a respective bending portion of a respective side wall of the two side walls.

### RELATED APPLICATIONS

This application claims priority from German patent application DE 10 2024 106 526.5, filed on Mar. 7, 2024, which is incorporated in its entirety by this reference.

### FIELD OF THE INVENTION

The invention relates to an electrical contact.

### BACKGROUND OF THE INVENTION

Generic electrical contacts are known in the art. These electrical contacts typically receive flat blade contacts in their plug in gap and are used in particular for flat plug in fuses that are very common in motor vehicles.

Electrical contacts of this type are typically produced by a stamping method. The contact lips forming the plug in gap taper towards each other slightly in the plug in direction. Inserting an opposite contact ideally spreads the contact lips so that they are oriented substantially parallel to one another and contact the opposite contact, in particular the flat blade contact, on a large contact surface. This provides a contact surface that suffices to conduct predetermined currents from the contact to the opposite contact.

This ideal condition, however, is hardly ever achieved. Part of the reason is fabrication tolerances when producing the contact. Another cause can be found in material tolerances of the flat blade contact. Last, not least, particular installation conditions require that the flat blade contact has to be inserted into the contact with an offset from a plug in gap center line at a predetermined angle or even with a predetermined relative rotation. This typically has the effect that a full surface contact of both contact lips at the flat blade contact that is being inserted is not assured.

When there is a lateral offset from the plug in gap center plane, one of the contact lips typically contacts the flat blade contact with an entire contact surface of the contact lip. The other contact lip, however, typically contacts the flat blade contact with an edge of its free end in a contact line.

When the flat blade contact is inclined relative to the plug in gap center plane, two diagonally opposite partial surfaces of the contact lips can contact the flat blade contact at the most when the contact lips are configured accordingly. Typically, however, only the edges of the contact lips that are ideally broken in the stamping process contact the flat blade contact.

A rotation of the flat blade contact about its vertical axis precludes a full surface contact of the contact lips on both sides.

When the contact and its opposite contact are inserted into one another, a less than ideal relative orientation, the mutual contact surfaces are reduced which substantially degrades the transition values from contact to opposite contact. Therefore, known contacts require safety offsets from their theoretical electrical transmission capability, in particular, for a transmission of high currents in order to comply with safety requirements.

Increasing electrification in motor vehicles, e.g. for a multitude of control devices or even battery electrical propulsion components, in plant engineering through the use of electronic control units and servo motors increasingly requires a transmission of high currents at comparatively low voltages in order to provide a sufficient amount of energy for operating various electrical components.

### BRIEF SUMMARY OF THE INVENTION

Thus, it is an object of the invention to optimize the contacting between a generic contact and an opposite contact configured as a flat blade contact, in particular, the contact of a fuse carrier and a flat plug in fuse in order to be able to also transfer high currents of up to 50 amperes, in particular at high ambient temperatures reliably.

The object is achieved by an electrical contact, comprising: two side walls arranged opposite to one another; a rear wall arranged between the two side walls, wherein the two side walls form a contact cage together with the rear wall; a plug in gap formed by two contact lips arranged opposite to one another, wherein each contact lip of the two contact lips forms a respective contact surface, wherein the respective contact surfaces of the two contact lips are oriented towards each other, wherein each contact lip of the two contact lips arranged in the contact cage is oriented essentially parallel to the two side walls, wherein each contact lip of the two contact lips is formed by a respective side wall section bent into the contact cage, wherein each respective side wall section forms a free end oriented away from a respective bending portion of a respective side wall of the two side walls; and a first plug in direction, wherein an opposite contact is pluggable into the plug in gap in the first plug in direction; wherein each contact lip includes at least one contact bud, wherein the contact buds of the two contact lips are oriented towards each other, and wherein the at least one contact bud of each contact lip forms the respective contact surface.

The contact bud which is configured as a camber protruding into the plug in gap, can compensate for three deviations from an ideal orientation between the contact and flat blade contact recited supra. The radius of the camber guarantees a predetermined minimum contact surface for each of the deviations and also for the ideal relative positioning so that the transferrable currents are computable precisely and are guaranteed in operations under real world conditions.

According to an advantageous embodiment, each contact bud extends parallel to an apex line of a bent portion of the side wall section that is bent inward into the contact cage in order to produce the contact lip.

Thus, the ideal contact bud for the contact according to the invention is elongated and forms a portion of an enveloping surface of a cylinder. Particularly advantageously, the contact bud extends over an entire length or entire width of the contact lip, depending on the reference direction. This way, the contact bud achieves a maximum contact surface with the flat blade contact functioning as an opposite contact. Additionally, the contact surface can be influenced positively by selecting a large radius of the contact bud camber.

According to an advantageous embodiment, each side wall section includes at least one incision introduced parallel to the apex line and the contact lip is arranged between the incision and the free end of the side wall section.

According to an advantageous embodiment, each contact lip forms a lip end in the portion of the incision of the associated side wall section, wherein the lip end is deflected about a bending axis that runs transversal to the apex line so that the plug in gap is expanded, wherein two lip ends that are arranged opposite to one another form a funnel shaped plug in guide.

This embodiment has two advantages. On the one hand side, this embodiment facilitates simplified insertion of the flat blade contact.

Additionally, this configuration of the contact lips is a prerequisite for facilitating additional plug in directions for inserting the flat blade contact into the plug in gap in addition to the first plug in direction recited supra. This will be discussed infra in more detail.

Particularly advantageously, the respective contact bud extends into the deflected lip end.

When the contact bud runs into the deflected lip end, the contact surface of the contact and the opposite contact can be improved even further when the arrangement deviates from the ideal relative positioning, in particular, when the opposite contact is inserted into the plug in gap at an angle.

Particularly advantageously, each side wall section includes two incisions arranged on an incision line oriented parallel to the apex line, each contact lip forms two lip ends arranged opposite to one another and the contact lips arranged opposite to one another form two funnel-shaped plug in guides arranged opposite to one another.

The invention is furthermore characterized in that the plug in gap is arranged opposite to the rear wall.

According to an advantageous embodiment, the first plug in direction is oriented transversal to the rear wall.

This embodiment essentially has the advantage that the cambered portions of the side walls that are created by bending the side walls into the contact cage in order to fabricate the contact lips form a first funnel shaped insertion contour for the opposite contact. Thus, implementing the first plug in direction does not require any additional plug in guides.

However, it is still possible to orient a second plug in direction parallel to the apex line, in particular, a third plug in direction can also be oriented parallel to the apex line, but opposite to the second plug in direction.

These two supplemental plug in directions can be implemented in particular when the funnel-shaped plug in guides are fabricated by deflecting the lip ends of the contact lips. Thus, it is possible to implement up to two additional plug in directions in addition to the first plug in direction which provides an electrical contact that is universally usable.

The contact according to the invention is intended to be used on a circuit board that is stuffed with components. Therefore, the contact cage forms at least one solder connection at a bottom side.

The solder connections can be provided for a through contact through the circuit board. It is also possible to form the solder connections as SMD connections and to form the positioning protrusions at the contact, wherein the positioning protrusions assure a positionally correct orientation of the contact on the circuit board in order to stuff the circuit board.

Accordingly, the second plug in direction is oriented towards the bottom side of the contact cage, wherein the third plug in direction can be additionally oriented towards the top side of the contact cage.

### BRIEF DESCRIPTION OF THE DRAWINGS

Advantageous embodiments of the invention are now described with reference to drawing figures, wherein:

FIG. 1 illustrates a perspective view of the contact according to the invention showing the plug in gap in a top view;

FIG. 2 illustrates the contact according to FIG. 1 in a view towards the rear wall;

FIG. 3 illustrates the contact according to FIG. 1 in a view towards its side walls according to the viewing arrow III in FIG. 2.

FIG. 4 illustrates a view of the contact according to FIG. 1 and according to the viewing arrow IV in FIG. 2;

FIG. 5 illustrates a view of the plug in gap of the contact according to FIG. 1 and according to the viewing arrow V in FIG. 3.

FIG. 6 illustrates a view according to the section line A-A in FIG. 5;

FIG. 7 illustrates a view according to the section line B-B in FIG. 4;

FIG. 8 illustrates a view according to the section line C-C in FIG. 4;

FIG. 9 illustrates a second embodiment of the contact according to the invention in a perspective view of the plug in gap; and

FIG. 10 illustrates a third embodiment of a contact according to the invention in a perspective view of its plug in gap.

### DETAILED DESCRIPTION OF THE INVENTION

The contact according to the invention is designated with roman numeral X in the drawing figures. Since this contact 10 is configured for transmitting high current, it is also designated as a high current contact 10.

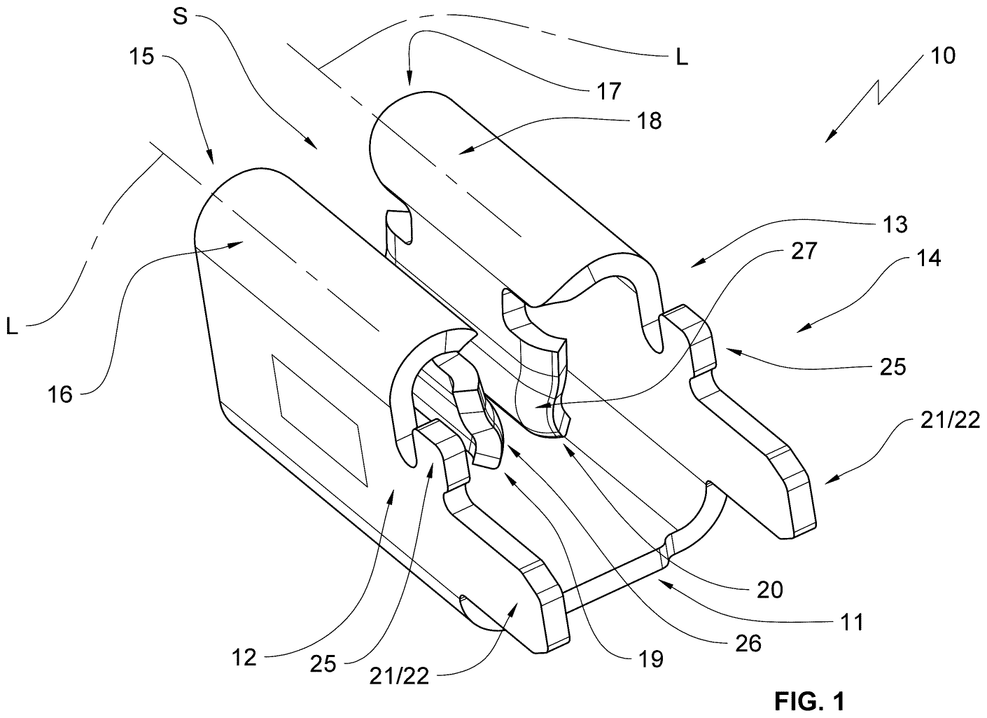

FIG. 1 shows the high current contact 10 in a perspective view. The high current contact 10 includes a rear wall 11 that is arranged between a first side wall 12 and a second side wall 13. The side walls 12, 13 form a contact page 14 together with the rear wall 11.

The first side wall 12 includes a first side wall section 15 which is bent inward into the contact cage 14 by approximately 165 to 180 degrees and thus forms a first bending area 16. This way, the first end of the first side wall section 15 is bent in a direction towards the rear wall 11.

The second side walls 13 forms a second side wall section 17. This second side wall section 17 is also bent at an angle of 165 to 180 degrees into the contact cage 14 which generates a second bending area 18. Also here, the free end of the second wall section 17 is oriented towards the rear wall 11 of the high current contact 10.

The first side wall section 15 of the first side wall 12 forms a first contact lip 19, the second side wall section 17 of the second wall 13 forms a second contact lip 20. The contact 10 forms a plug in gap F between the contact lips 19, 20.

Last not least the contact 10 in the embodiment according to FIG. 1 includes two solder connections 21 configured as soldering legs 22 which are configured to be inserted into corresponding openings of a circuit board and soldered therein.

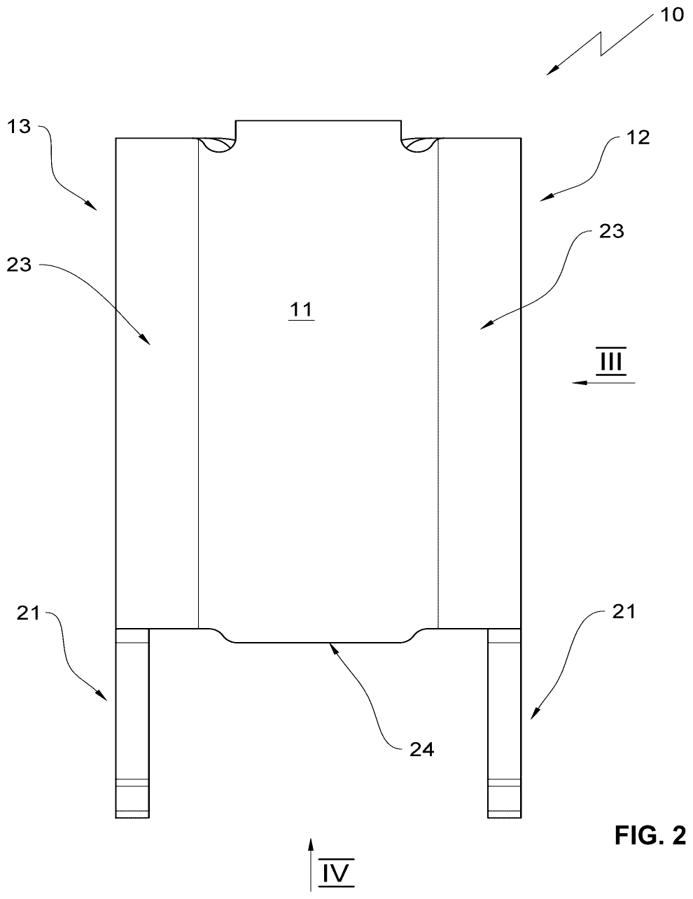

FIG. 2 shows a view of a rear wall 11 of the contact 10. In combination with FIG. 1, it is clear that the rear wall is connected to the side walls 13 by a curved section 23.

A contact bar 24 protrudes towards a bottom side of the contact 10 supporting the solder connections 21, wherein the contact bar 24 cooperates with the contact fingers 25 of the side walls 12, 13 according to FIG. 1 in a manner that will be described infra.

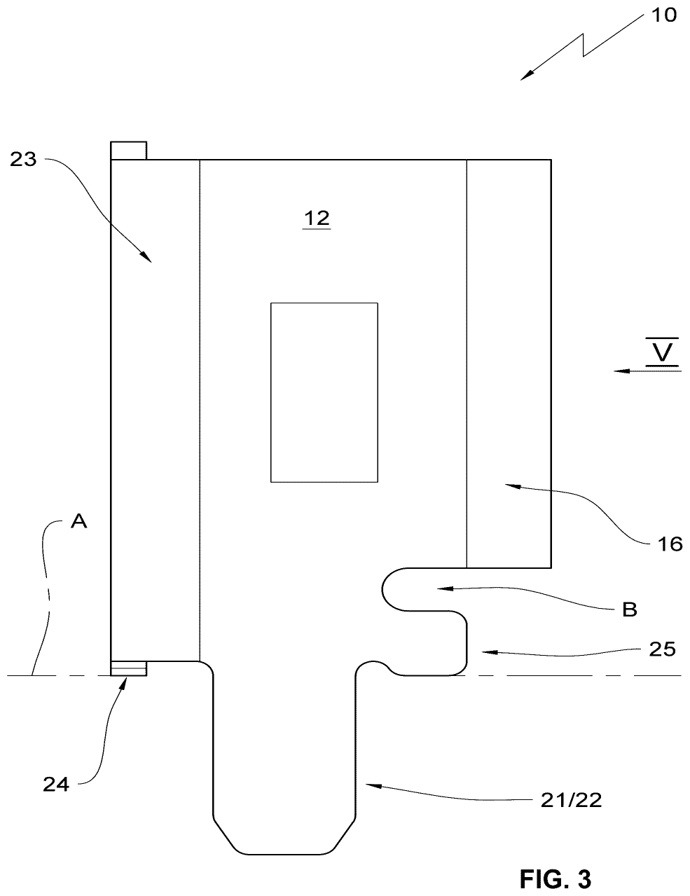

FIG. 3 shows a side view according to the viewing arrow III in FIG. 2. FIG. 3 looks at the first side wall 12. The description provided infra applies accordingly to the second side wall 13. Initially, a curved section 23 is visible and the side wall 12 of a rear wall 11 is connected at the curved section 23. FIG. 3 also shows the contact bar 24 of the rear wall 11 and the solder connection 21, which is configured in this embodiment as a soldering leg 22. The first bending portion 16 is visible on a front side, oriented away from the rear wall 11, wherein the first bending portion 16 is generated by bending the first side wall section 15 into the contact cage 14.

The first side wall 12 forms a contact finger 25 towards the contact bottom side. This transition is formed by a bend B so that the contact finger 25 is formed below the bending portion 16. Thus, the bend B is, therefore, arranged between the first bending portion 16 and the contact finger 25 and thus facilitates bending the first side wall section 15 into the contact cage without deforming the contact finger 25.

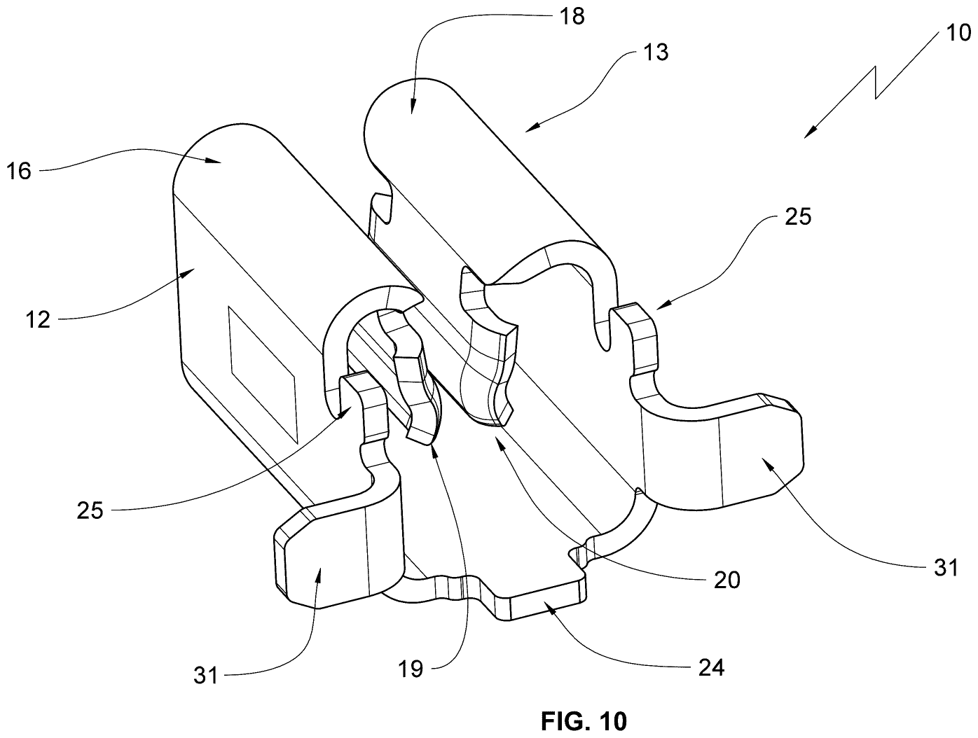

FIG. 10 shows that the contact bar 24 and the contact finger 25 terminate in a joint contact plane A towards a bottom side of the contact. The top side of the circuit board is arranged in the contact plane and the contact 10 is arranged on the top side of the circuit board. The contact bar 24 and the contact fingers 25 of the side walls 12 facilitate a perpendicular orientation of the contact 10 on a circuit board.

FIG. 4 shows a view of a bottom side of the contact 10 according to a viewing arrow IV in FIG. 2. FIG. 4 shows that the side wall sections 15 and 17 are not bent into the contact cage 14 by 180 degrees but have a slightly smaller bending angle thus approximately 175 degrees. This generates a wedge-shaped taper of the plug in gap S which is only extended by inserting an opposite contact, in particular, a flat blade contact. This assures a contact pressure of the contact lips 19, 20 at the flat blade contact.

It is evident from FIG. 4 that both contact lips 19, 20 form a first contact bud 26 and a second contact bud 27. Both contact buds 26, 27 are oriented towards each other and tighten the plug in gap S even further. Both contact buds have a cambered surface that can be configured as an enveloping surface of a cylinder.

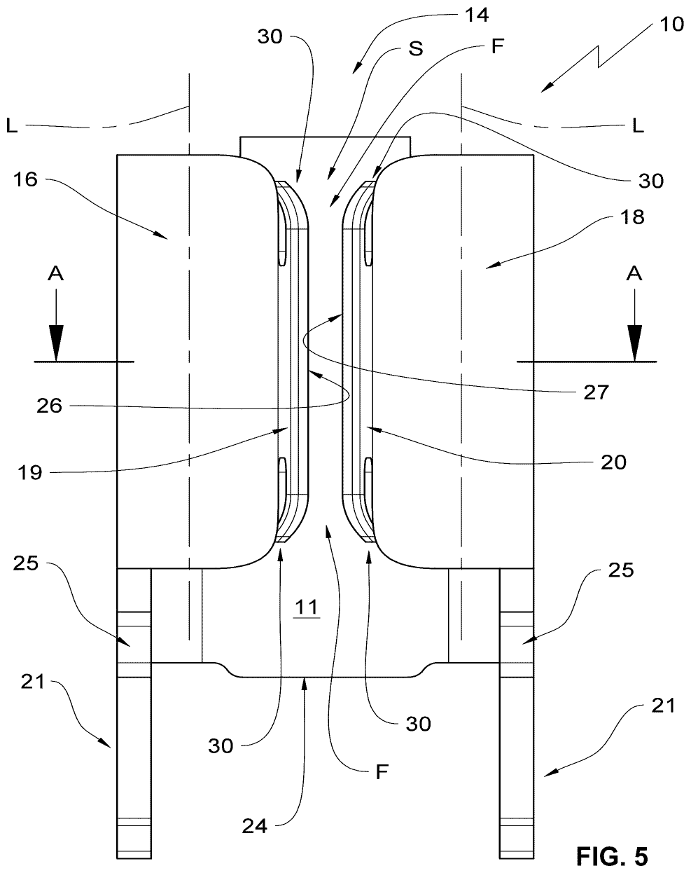

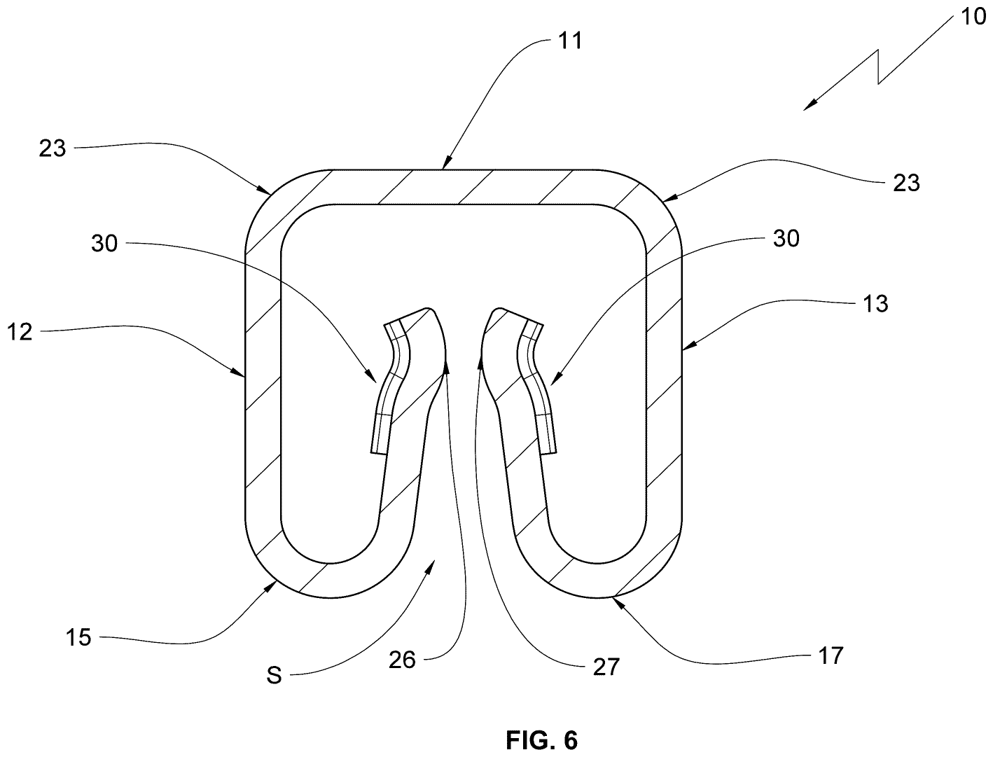

FIG. 5 shows a view of a front side of the contact 10 arranged opposite to the rear wall 11. This is a view into the plug in gap S where the contact buds 26, 27 are arranged at the contact lips 19, 20 oriented towards each other. Additionally, apex lines L are shown like in FIG. 1 which respectively represent an apex of the bending portion 16, 18.

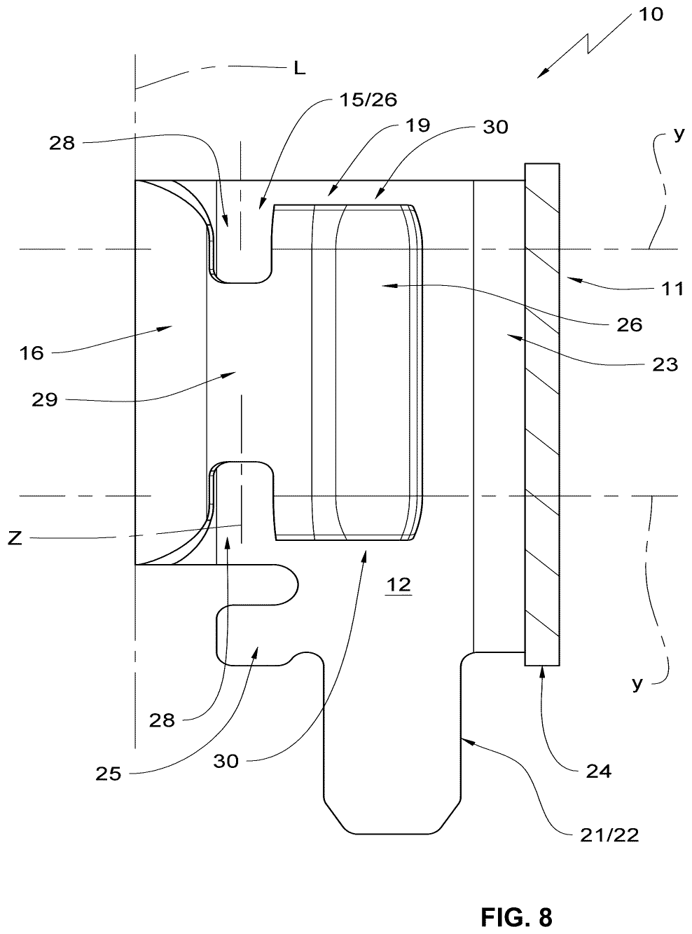

FIG. 8 shows a sectional view according to the sectional line C-C in FIG. 4. This view shows an inside view of the contact cage 14 onto the inner surface of the first side wall 12. This shows that the first side wall section 15 includes two incisions 28. The incisions 28 are on an incision line Z that is oriented parallel to the apex line L. The first incision 28 is introduced from a contact top side into the first side wall section 15. The second incision 28 is introduced from the contact bottom side into the first side wall section 15. A material bar 29 remains between the incisions 28. Thus, the first contact lip 26 is formed between the incisions 28 and the free end of the side wall section.

The first contact lip 19 forms an upper lip end and a lower lip end 30 in the area of each incision 28. Each lip end 30 is deflected along a bending axis Y in a direction towards the first side wall 12. The bending axis Y runs orthogonal to the apex line L.

The second side wall 13 including the second side wall section 17 is configured accordingly.

Looking back at FIG. 5, it is evident that the deflected lip ends 30 of the contact lips 19, 20 form a funnel-shaped plug in guide F from the contact top side and also from the contact bottom side. This facilitates inserting opposite contacts, in particular flat blade contacts from the contact top side as well as from the contact bottom side.

It is evident from FIGS. 8 and 1 and 5 and 7 that the contact buds 26, 27 extend over an entire length of the contact buds 26, 27 that is parallel to the apex line L and into the deflected lip ends 30.

FIG. 6 shows a cross-sectional view of the contact 10 according to the sectional line A-A in FIG. 5. This illustration shows how the plug in gap S is narrowed by the contact buds 26, 27 protruding into the plug in gap S. It is evident that the contact buds 26, 27 are configured to always provide a defined contact surface and thus assure a transmission of high currents even when the opposite contact is inserted offset, inclined, or twisted.

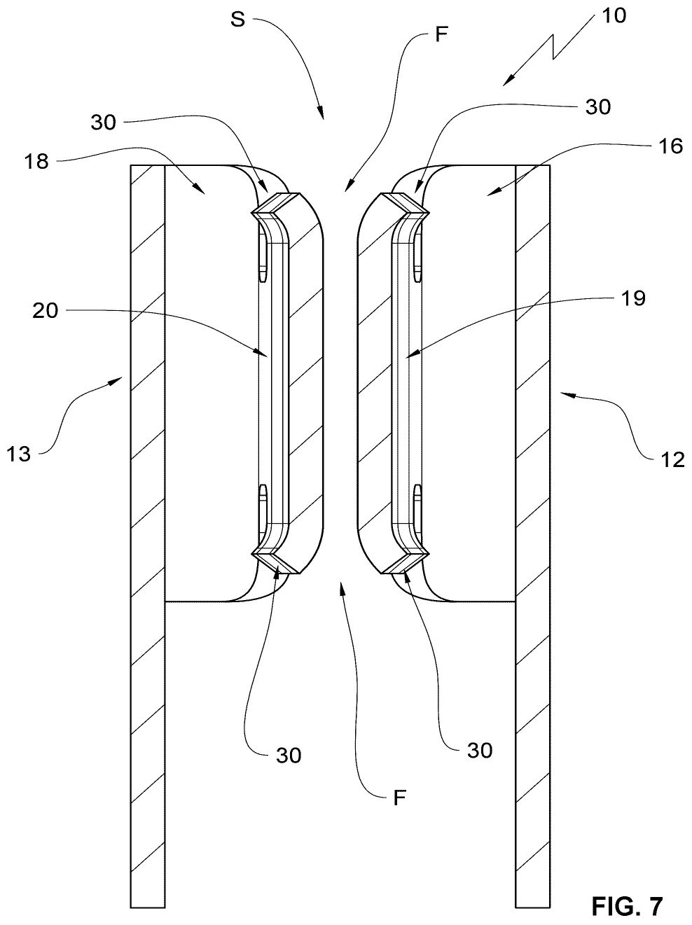

FIG. 7 shows a longitudinal sectional view according to the sectional line B-B in FIG. 4. This view runs from the rear wall 11 in a direction towards the contact front side or in a direction towards the plug in gap S. This illustration also shows how the plug in gap 11 is formed between the contact lips 19, 20, wherein their lip ends 30 deflected towards the adjacent side wall 12, 13 form an upper and a lower plug in guide F.

It is evident in combination with the other FIGs., in particular in combination with FIG. 1 that the first plug in direction runs from the contact front orthogonally in a direction towards the rear wall 11. A flat blade contact can be inserted into the high current contact 10 along this first plug in direction and the flat blade contact is contacted by the contact buds 26, 27.

A second plug in direction and a third plug in direction can be defined from the contact top side or from the contact bottom side, thus orthogonal to the first plug in direction or parallel to the apex line L. Flat blade contacts can also be inserted into the high current contact 10 along this plug in direction.

A circuit board arranged at the bottom side of the high current contact 10 can include a cutout that is in line with the plug in gap S, so that the flat blade contact can be inserted into the high current contact 10 through the circuit board.

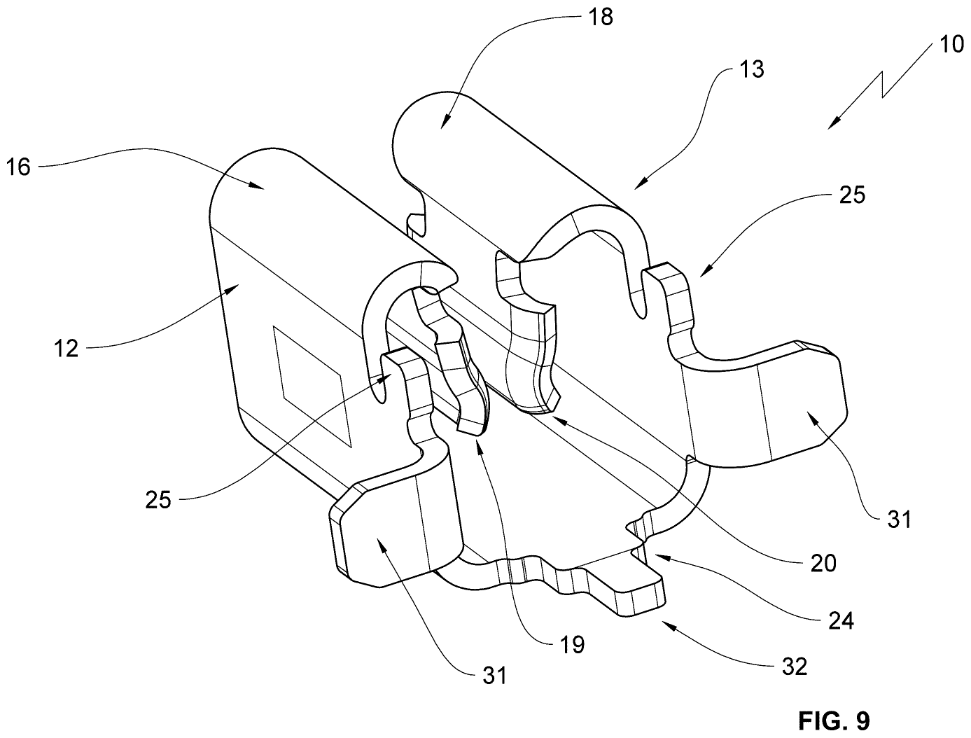

FIG. 9 shows a second embodiment of the high current contact 10 according to the invention. This high current contact is substantially identical to the high current contact 10 described supra. There are no significant differences in particular in the area of the contact lips 19, 20 forming the plug in gap 11. This embodiment has contact legs 31 instead of the soldering legs 22 wherein the contact legs 31 are configured to contact the contact surfaces of a circuit board and to be soldered thereon. A positioning mandrel 31 originates from the contact bar 24 and positions the high current contact 10 on the circuit board correctly in order to subsequently solder the contact legs 31 at the contact surfaces.

The third embodiment according to FIG. 10 is similar to the embodiment according to FIG. 9. Also in this embodiment, there is no difference with respect to the contact lips 19, 20 and the configuration of the plug in gap from the first embodiment. The embodiment according to FIG. 10 omits the positioning mandrel 32 of the high current contact 10 of FIG. 9.

### REFERENCE NUMERALS AND DESIGNATIONS

10 contact/high current contact
11 rear wall
12 first side wall
13 second side wall
14 contact cage
15 first side wall section
16 first bending area
17 second side wall section
18 second bending area
19 first contact lip
20 second contact lip
21 soldering connection
22 soldering leg
23 cambered section
24 contact bar
25 contact finger
26 first contact bud
27 second contact bud
28 incision
29 material bar
30 lip end
31 contact leg
32 positioning mandrel
F plug in guide
S plug in gap
L apex line
B bending section
A contact plane
Z incision line
Y bending axis

What is claimed is:

1. An electrical contact, comprising:
two side walls arranged opposite to one another;
a rear wall arranged between the two side walls, wherein the two side walls form a contact cage together with the rear wall;
a plug in gap formed by two contact lips arranged opposite to one another,
wherein each contact lip of the two contact lips forms a respective contact surface,
wherein the respective contact surfaces of the two contact lips are oriented towards each other,
wherein each contact lip of the two contact lips arranged in the contact cage is oriented essentially parallel to the two side walls,
wherein each contact lip of the two contact lips is formed by a respective side wall section bent into the contact cage,
wherein each respective side wall section forms a free end oriented away from a respective bending portion of a respective side wall of the two side walls; and
a first plug in direction, wherein an opposite blade contact is pluggable into the plug in gap in the first plug in direction;
wherein each contact lip includes at least one respective contact bud,
wherein the respective contact buds of the two contact lips are oriented towards each other, and
wherein the at least one contact bud of each contact lip forms the respective contact surface.

2. The electrical contact according to claim 1, wherein the at least one contact bud extends parallel to an apex line of the bending portion of the respective side wall section that is bent into the contact cage to form each contact lip.

3. The electrical contact according to claim 2, wherein each respective side wall section includes at least one incision introduced parallel to the apex line, and wherein the contact lip is arranged between the incision and the free end of the side wall section.

4. The electrical contact according to claim 3,
wherein each contact lip forms a respective lip end in an area of the incision of the respective side wall section,
wherein the lip end is bent out about a bending axis running transversal to the apex line, so that the lip end expands the plug in gap, and
wherein two of the respective lip ends arranged opposite to one another form a funnel shaped plug in guide.

5. The electrical contact according to claim 4, wherein the at least one contact bud extends into the bent out lip end.

6. The electrical contact according to claim 4,
wherein each respective side wall section includes two incisions arranged on an incision line arranged parallel to the apex line,
wherein each contact lip forms two lip ends arranged opposite from one another, and
wherein the opposite contact lips form two funnel shaped plug in guides arranged opposite to one another.

7. The electrical contact according to claim 1, wherein the plug in gap is arranged opposite to the rear wall.

8. The electrical contact according to claim 1, wherein the first plug in direction is oriented transversal to the rear wall.

9. The electrical contact according to claim 8, wherein a second plug in direction is oriented parallel to the apex line.

10. The electrical contact according to claim 9, wherein a third plug in direction is also parallel to the apex line but oriented opposite to the second plug in direction.

11. The electrical contact according to claim 1, wherein the contact cage forms at least one solder connection at a bottom side.

12. The electrical contact according to claim 9,
wherein the contact cage forms at least one solder connection at a bottom side, and
wherein the second plug in direction is oriented towards the bottoms side of the contact cage.

13. The electrical contact according to claim 10,
wherein the contact cage forms at least one solder connection at a bottom side, and
wherein the third plugin direction is oriented towards a top side of the contact cage.
